(19) United States
(12) Patent Application Publication
(10) Pub. No.: US 2006/0253895 A1
(43) Pub. Date: Nov. 9, 2006

(54) Video communication call authorization

(76) Inventors: Michael Brandofino, Hillside, NJ (US); Andreas Eriksson, Hillside, NJ (US)

Correspondence Address: MORRISON & FOERSTER LLP, 1650 TYSONS BOULEVARD, SUITE 300, MCLEAN, VA, 22102, US

(21) Appl. No.: 11/391,673

(22) Filed: Mar. 29, 2006

Related U.S. Application Data
(60) Provisional application No. 60/665,843, filed on Mar. 29, 2005.

(51) Int. Cl. H04L 9/32

(52) U.S. Cl. 726/2

(57) ABSTRACT

The disclosed systems and methods provide a centrally located call manger for authorizing calls from a caller to a recipient. In particular, the systems and methods relate to using a centralized store of authorization parameters relating to one or more appliances, callers, recipients, or content types. Packet-based communications between a caller and a recipient can be allowed or denied based on the stored authorization data.

### REFERENCE TO RELATED APPLICATIONS

This application claims priority to U.S. Provisional Application No. 60/665,843, filed Mar. 29, 2005, the contents of which are hereby incorporated by reference.

### FIELD OF THE INVENTION

The invention relates to using a centrally located call manger to authorize calls from a caller to a recipient. In particular, this invention relates to using a centralized database of authorization parameters relating to one or more appliances, callers, recipients, or content types to permit or deny a connection attempt between a caller and a recipient.

### BACKGROUND

Those in control of communication networks have long sought to control use of networks and devices attached to those networks. In traditional phone systems, there are few controls implemented to give an individual or administrator the ability to control inbound and outbound calling at a content or application level. Limited exceptions are found in the ability to limit access to specified services such as “900” services and long distance. Most users of traditional phone networks have no ability to block specified callers or allow specified callers.

As personal video conferencing systems become more widely adopted, individuals can communicate as easily with video as they have in the past using a standard telephone. The need and desire to control access still exists in this new medium. Both individual users of video conferencing equipment and administrators of those systems still need to control access to the network. Thus, there exists a need for systems and methods that allow centralized access control on video conferencing networks.

### SUMMARY OF THE INVENTION

This invention includes systems, methods and computer-readable media for authorizing packet-based network calls.

In one embodiment, the method for authorizing packet-based network calls includes receiving an authorization parameter associated with a caller endpoint, storing the caller endpoint authorization parameter in a database, receiving a call request from the caller endpoint to initiate a call to a destination endpoint, retrieving the caller endpoint authorization parameter from the database, and determining if the caller endpoint is authorized to place a call to the destination endpoint based on the caller endpoint authorization parameter retrieved from the database.

In another embodiment, the method for authorizing packet-based network calls includes receiving an authorization parameter associated with a destination endpoint, storing the destination endpoint authorization parameter in a database, receiving a call request from a caller endpoint to initiate a call to the destination endpoint, retrieving the destination endpoint authorization parameter from the database, and determining if the destination endpoint is authorized to receive a call from the caller endpoint based on the destination endpoint authorization parameter retrieved from the database.

In another embodiment, the system for authorizing packet-based network calls includes a call manager configured for receiving an authorization parameter associated with a caller endpoint, storing the caller endpoint authorization parameter in a database, receiving a call request from the caller endpoint to initiate a call to a destination endpoint, retrieving the caller endpoint authorization parameter from the database, and determining if the caller endpoint is authorized to place a call to the destination endpoint based on the caller endpoint authorization parameter retrieved from the database.

In another embodiment, the machine-readable medium includes program code for receiving an authorization parameter associated with a caller endpoint, storing the caller endpoint authorization parameter in a database, receiving a call request from the caller endpoint to initiate a call to a destination endpoint, retrieving the caller endpoint authorization parameter from the database, and determining if the caller endpoint is authorized to place a call to the destination endpoint based on the caller endpoint authorization parameter retrieved from the database.

Further embodiments include methods, systems and machine-readable media for receiving the authorization parameter from an administrator and whereby if the caller endpoint is not authorized to call the destination endpoint, determining an alternative destination endpoint based on a predefined alternative routing rule and initiating a call to the alternative destination endpoint and wherein the authorization parameter includes a wildcard defining a plurality of endpoints, defines one or more users, types of content, or communication appliances.

### BRIEF DESCRIPTION OF THE DRAWINGS

FIG. 1 illustrates an exemplary network architecture.

FIG. 2 illustrates an exemplary procedure for authorizing a call.

### DETAILED DESCRIPTION OF THE INVENTION

Overview of Authorization

The systems and methods described herein can be used to provide control for the use of real-time video communications for live, interactive communication between two or more parties. An authorization service can determine if a calling party can place a call to another party based upon a defined list applied to the caller (a first endpoint) and receiver (a second endpoint) which determines if the communication is authorized.

This system has many applications that can allow a user or administrator to control the use of a video communication device by, for example, employees and uninvited inbound calling parties. In some embodiments, parents can apply parental control for children to assure they are not accessing inappropriate content or being solicited by inappropriate conversations.

The systems and methods described herein can be implemented by using any TCP/IP or packet-based communication protocol or application which can perform call management tasks including identifying a caller and recipient to determine if communication between the parties is authorized or if permission should be denied. The system can be also based upon the logic of a call manager centrally located on the network infrastructure. While the functionality of the call manager can be implemented at a local software application or device being used to communicate, in the preferred embodiment, it is centrally located. This service can be either used at a business grade level of a central system managed by a company or provided to businesses and consumers by a service provider.

System Architecture

The system can be configured to act as an intelligent call manager programmable by an administration interface to set rules the call manager will follow to determine on a call by call basis if a call is authorized to complete or is denied based upon restrictions set for the caller, recipient, or both.

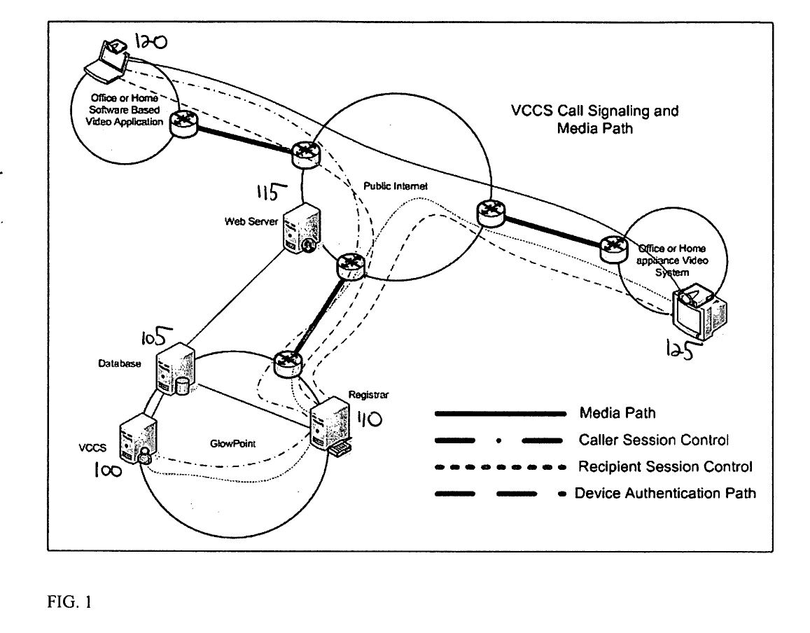

Exemplary elements of the system are illustrated in FIG. 1. The Video Communication Control System (VCCS) 100 or call manager provides an administrative interface for controlling call authorization. The VCCS can make call authorization decisions based on call authorization data parameters retrieved from database 105. Database 105 can be stored on the same device as the VCCS 100 or on a separate, network-accessible, device as illustrated in FIG. 1.

Registrar 110 can be configured to perform any and all of the functions typically performed by an H.323 gatekeeper or a SIP registrar in a communication network including providing services such as address translation and network access control for standards-based SIP clients and H.323 terminals, gateways, and MCUs. Registrar 100 can also provide services such as bandwidth management, accounting, and a centralized dial plan.

Web server 115 can be used to provide a host for any web based administrative applications or other functions typically provided by a web server in a packet-based communication network.

Multiple video conferencing clients 120, 125 can be connected to the network and communications between them can be administered by the VCCS 100. As shown in FIG. 1, a first client 120 can be an office or home based video application and a second client 125 can be an office of home based appliance video system. One of ordinary skill in the art would recognize that any number of various video conferencing clients could be connected to the network.

Call Authorization Process

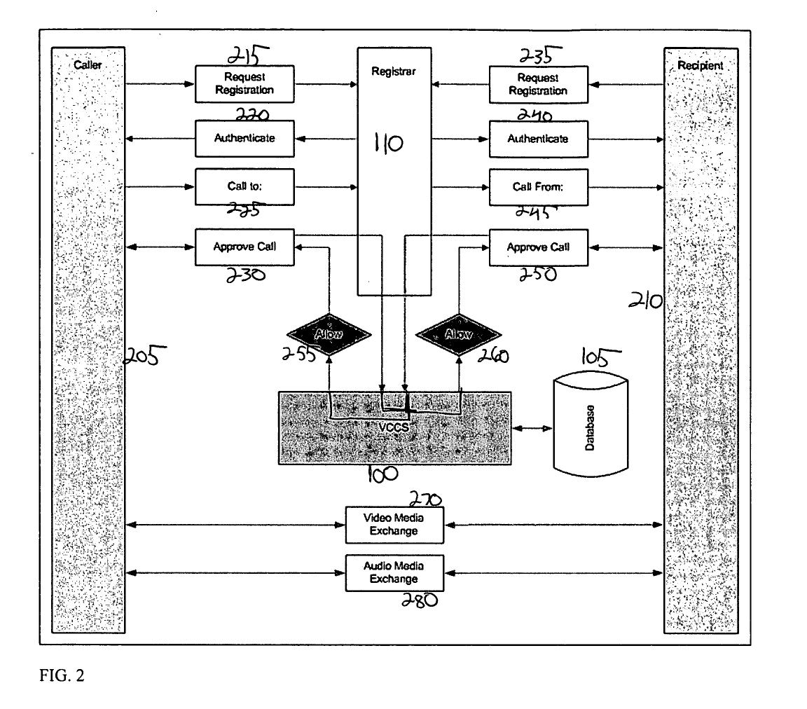

FIG. 2 illustrates an exemplary process for authenticating with the system and sending requests to authorize a call to be connected between a caller and a recipient. Since both parties can have control over the type and origins of content that can be accessed or received, the system can be configured to check for approval from both parties based on predefined parameters for both parties.

In the example of FIG. 2, a caller 205 may wish to connect to a recipient 210. In some embodiments, before a call can be completed, caller 205 must register with registrar 110 by requesting registration 215 with registrar 110. Successful registration results in authentication 220 of the caller 205. In some embodiments, before a call can be completed, a recipient 210 must also register with registrar 110 by requesting registration 235 with registrar 110. Successful registration results in authentication 240 of the recipient 210. A caller 205 can then initiate a call request 225 to recipient 210. Registrar 110 can be in communication with VCCS 100. VCCS 100 can be in communication with database 105 which can be configured to store authorization parameter data. If the VCCS 100 allows 260 the call from caller 205 to recipient 210, the call will be approved 250 to proceed to connect with recipient 210. Similarly, if the VCCS 100 allows 255 a call from recipient 210 to caller 205, that call will also be approved 230.

After approval of the call, video data 270 and audio data 280 can be exchanged between the parties.

Configuration

Configuration settings including authorization settings can be programmed and can be applied at a login or registration level to allow the settings to be applied based on an individual appliance or based upon an individual user that is logged in to use that appliance.

In some embodiments, when an endpoint such as caller 205 or recipient 210 sends a call-signaling message to the gatekeeper or registrar 110, the gatekeeper or registrar may accept or reject the call, according to a standard specification such as H.225. The reasons for rejection may include, but are not limited to, restricted access to/from particular users, terminals or gateways. In some embodiments, the gatekeeper can restrict access to certain terminals or gateways and/or have time-of-day policies to restrict access.

In some embodiments, a corporate management information system (MIS) or information technology (IT) management can have the ability to determine the criteria as to whether or not authorization for a call passes or fails, based on security reasons such as restricted access to services or out-of-zone calls. In some embodiments, an administrator may choose to admit all requests under certain low-use circumstances.

Authorization Parameters

Entities such as callers and recipients as well as administrators can have the ability to create a call restriction or authorization parameter list which provides definable rules for receiving calls from and placing calls to other entities. In some embodiments, this authorization or restriction can be applied above any other rule set by the system. In some embodiments, the call list can be stored on database 105.

The call restriction parameter list can be a table of defined callers and destinations that the specific user or device is authorized to call. When a call is placed, the VCCS can identify the calling party, identify the receiving party, and examine the calling party's parameter list to determine if the call is authorized to complete. Additionally, the VCCS can compare the receiving party's parameter list to determine if the call is authorized to be received.

Some embodiments can be configured to allow outbound calls to all destinations that are not explicitly blocked while restricting all inbound calls unless predefined as allowable. In some embodiments, wildcard settings can be used to allow certain call patterns.

As non-limiting examples, the call restriction parameter list can be configured for approving or disapproving connections based on content type, protocol type, appliance vendor code, user identification, hostname or IP address. Based on the call restriction parameter list, calls can be permitted access if the conditions are matched or denied when there is a match.

The call restriction parameter list can include a list of endpoints known to the gatekeeper or registrar. In some embodiments, calls from these endpoints are accepted by the gatekeeper even if the endpoints are located in a different domain.

The systems described herein can also be configured to identify a caller as a user on a list of unauthorized users (i.e., a black list). Thus, the users on the black list are denied access to the service, or provided with a phone number to call instead of being connected, or transferred to an operator, while any other user not on the list is permitted access.

The alternative routing rules described in co-pending U.S. patent application Ser. No. 11/246,956 which is hereby incorporated by reference, can also be used. If a call is not authorized to be completed between a caller and a recipient, a call policy manager can then lookup the a pre-defined rule to determine if any apply to the event of the particular call failure condition. If a rule defining an alternate destination exists for the destination, the call policy manager will then route the call to that new destination. These defined rules and other rules can be included as part of a predefined alternative routing rule set. As a non-limiting example, a system administrator or any other user can configure the alternative routing rules. The alternative routing rules could, as non-limiting examples, specify that calls will be routed to a video call assistant, a video auto attendant, a video mail server, or any other endpoint capable of receiving a call. These rules can also include one or more user-supplied conditional parameters or parameters stored with the call restriction parameter list.

Entertainment Software Rating Board Classification

Some embodiments of the system can include the ability to provide a rating system to classify content. In some embodiments, the content rating and classification system developed by the Entertainment Software Rating Board (ESRB) can be used. In those embodiments, the VCCS can be configured to recognize a calling party's ESRB rating, identify ESRB restrictions applied to recipients or callers and determine whether the call is permitted to be completed.

Some communications can carry a notice warning a party to a call that content created another party has not been rated by the ESRB.

Control Interface

Some embodiments can include a web based interface for providing a management console to create and manage the call restriction parameter list. The interface can be designed to allow password authentication so individual usemame and passwords that would be used to log in and use a system can either be setup by a group administrator or by the individual. In order to apply security to the settings, an administrator account can be created by default. The administrator can be given rights to modify the settings and add entries into the call lists. A user can have the ability to view the settings but may be unable to make certain modifications.

One of ordinary skill in the art would appreciate that any of the rules, parameters and configuration options described herein can be provided though a web interface and made available to users on stationary as well as on mobile devices. An online portal could also be used to allow administrators and user to add and modify restrictions and preferences without manual intervention and processing by the service provider.

While the above description is provided with reference to the Internet and other networks, one of skill in the art would recognize that any wired or wireless network that provides for addressable endpoints could be used. The networks described above may or may not include portions of the Internet. One of skill in the art would also recognize that while individually addressable endpoints allow specific content to be delivered to individual users, the network and systems could be used to broadcast the same content to a plurality of users.

Additionally, while reference may be made to specific codecs in the above description, any standards based audio or videoconferencing codec resident on a computing platform or in an appliance, in any environment, could be used in the described systems and methods. One of ordinary skill in the art would recognize that the systems and methods described herein can be implemented on any software or hardware platform.

The above description is presented to enable a person skilled in the art to make and use the invention, and is provided in the context of a particular application and its requirements. Various modifications to the preferred embodiments will be readily apparent to those skilled in the art, and the generic principles defined herein may be applied to other embodiments and applications without departing from the spirit and scope of the invention. Thus, this invention is not intended to be limited to the embodiments shown, but is to be accorded the widest scope consistent with the principles and features disclosed herein.

1. A method for authorizing packet-based network calls, the method comprising:
receiving an authorization parameter associated with a caller endpoint;
storing the caller endpoint authorization parameter in a centralized database;
receiving a call request from the caller endpoint to initiate a call to a destination endpoint;
retrieving the caller endpoint authorization parameter from the database; and
determining if the caller endpoint is authorized to place a call to the destination endpoint based on the caller endpoint authorization parameter retrieved from the database.

2. The method of claim 1, further comprising:
if the caller endpoint is not authorized to call the destination endpoint, determining an alternative destination endpoint based on a predefined alternative routing rule and initiating a call to the alternative destination endpoint.

3. The method of claim 1, further comprising receiving the authorization parameter from an administrator.

4. The method of claim 1, wherein the authorization parameter further comprises a wildcard defining a plurality of endpoints.

5. The method of claim 1, wherein the authorization parameter defines one or more users.

6. The method of claim 1; wherein the authorization parameter defines one or more types of content.

7. The method of claim 1, wherein the authorization parameter defines one or more communication appliances.

8. A method for authorizing packet-based network calls, the method comprising:
receiving an authorization parameter associated with a destination endpoint;
storing the destination endpoint authorization parameter in a centralized database;
receiving a call request from a caller endpoint to initiate a call to the destination endpoint;
retrieving the destination endpoint authorization parameter from the database; and
determining if the destination endpoint is authorized to receive a call from the caller endpoint based on the destination endpoint authorization parameter retrieved from the database.

9. The method of claim 8, further comprising:
receiving an authorization parameter associated with the caller endpoint;
storing the authorization parameter in the database;
retrieving the caller endpoint authorization parameter from the database;
determining if the caller endpoint is authorized to place a call to the destination endpoint based on the caller endpoint authorization parameter retrieved from the database; and
establishing a packet-based communications session between the caller endpoint and destination endpoint only if the caller endpoint is authorized to place a call to the destination endpoint and the destination endpoint is authorized to receive a call from the caller endpoint.

10. The method of claim 9, wherein the authorization parameter further comprises a wildcard defining a plurality of endpoints, a plurality of users, communication appliances, or types of content.

11. A system for authorizing packet-based network calls, the system comprising a call manager configured for:
receiving an authorization parameter associated with a caller endpoint;
storing the caller endpoint authorization parameter in a centralized database;
receiving a call request from the caller endpoint to initiate a call to a destination endpoint;
retrieving the caller endpoint authorization parameter from the database; and
determining if the caller endpoint is authorized to place a call to the destination endpoint based on the caller endpoint authorization parameter retrieved from the database.

12. The system of claim 11, wherein, the call manager is further configured for determining an alternative destination endpoint based on a predefined alternative routing rule and initiating a call to the alternative destination endpoint if the caller endpoint is not authorized to call the destination endpoint.

13. The system of claim 11, wherein the call manager is configured for receiving authorization information from an administrator.

14. The system of claim 11, wherein the authorization parameter further comprises a wildcard defining a plurality of endpoints.

15. The system of claim 11, wherein the authorization parameter defines one or more users.

16. The system of claim 11, wherein the authorization parameter defines one or more types of content.

17. The system of claim 11, wherein the authorization parameter defines one or more communication appliances.

18. A machine-readable medium having program code stored thereon which, when executed by a machine, causes the machine to perform a method, the method comprising:
receiving an authorization parameter associated with a caller endpoint;
storing the caller endpoint authorization parameter in a centralized database;
receiving a call request from the caller endpoint to initiate a call to a destination endpoint;
retrieving the caller endpoint authorization parameter from the database; and
determining if the caller endpoint is authorized to place a call to the destination endpoint based on the caller endpoint authorization parameter retrieved from the database.

19. The machine-readable medium of claim 18, the method further comprising:
receiving an authorization parameter associated with a destination endpoint;
storing the destination endpoint authorization parameter in the database;
retrieving the destination endpoint authorization parameter from the database;
determining if the destination endpoint is authorized to receive a call from the caller endpoint based on the destination endpoint authorization parameter retrieved from the database; and
establishing a packet-based communications session between the caller endpoint and destination endpoint only of the caller endpoint is authorized to place a call to the destination endpoint and the destination endpoint is authorized to receive a call from the caller endpoint.

20. The machine-readable medium of claim 18, wherein the authorization parameter further comprises a wildcard defining a plurality of endpoints, a plurality of users, communication appliances, or types of content.
